(19) United States
(12) Patent Application Publication
(10) Pub. No.: US 2008/0017258 A1
(43) Pub. Date: Jan. 24, 2008

(54) BRIDGE MIXER TAP

(76) Inventors: William Peter HERRING, Bath (GB); James Moore, Frome (GB)

Correspondence Address: STITES & HARBISON PLLC, 1199 NORTH FAIRFAX STREET, SUITE 900, ALEXANDRIA, VA, 22314, US

(21) Appl. No.: 11/777,437

(22) Filed: Jul. 13, 2007

(30) Foreign Application Priority Data
Jul. 20, 2006 (GB) 0614470.3

(51) Int. Cl. F16K 11/00

(52) U.S. Cl. 137/597

(57) ABSTRACT

A bridge mixer tap has two interconnected tap pillars and a spout extending from the interconnection. Each pillar has an inlet and an adjustable flow controller for controlling flow from the inlet. One pillar permits fluid flow to the spout via the interconnection, while the other pillar is sealed from the spout in the interconnection. Flow from each of the two inlets is channelled to a valve, which allows the mixed fluids from the two inlets to be directed either along the pillar that is in fluid communication with the spout or to a separate spray unit.

### BACKGROUND OF THE INVENTION

The present invention relates to a bridge mixer tap having an outlet spout and optionally a spray unit.

### DESCRIPTION OF THE PRIOR ART

Bridge mixer taps normally comprise two tap pillars connected by a bridge, and a spout extending from the middle of the bridge. This arrangement is attractive to consumers due to its traditional appearance.

Normally, the two tap pillars provide a hot and a cold water supply to the bridge, where the two water supplies are then mixed. Handles on the tap pillars are used to regulate the amount and relative proportion of hot and cold water that enters the mixing chamber.

However, in some instances the bridge mixer taps comprise a spray unit to act as a supplementary water outlet to the spout. This arrangement presents some difficulties, as mixed water cannot be supplied to the spray unit from the bridge without interfering with the traditional appearance of the bridge mixer tap.

Hence several attempts have been made to provide a supply of mixed water to the spray that does not interfere with the traditional appearance of the bridge mixer tap.

In GB 2394525 the hot and cold water supplies of two tap pillars are mixed in the bridge as in a traditional bridge mixer tap. The mixed water is then fed either directly into the spout or into the spray unit via a duct. This duct runs inside one of the tap pillars and feeds mixed water to a flexible conduit connected to the tap pillar below a work surface (and hence out of sight of the user) on which the bridge mixer tap is mounted. The flexible conduit then feeds the mixed water into the spray unit.

In GB 2361047 the hot and cold water supplies of the two tap pillars are fed into a separate mixing chamber located between the tap pillars below a work surface (and hence out of sight of the user) on which the bridge mixer tap is mounted. The mixed water is then either fed to the spout via both of the tap pillars or to the spray via a flexible conduit connected to the mixing chamber.

In both GB 2 361 047 and GB 2 394 525 handles on the tap pillars are used to regulate the amount and relative proportion of hot and cold water that enters the mixing chamber.

### SUMMARY OF THE INVENTION

The present invention provides alternative bridge mixer taps optionally comprising a spray unit.

At its most general, the present invention provides a bridge mixer tap with two interconnected pillars and a spout extending from the interconnection. In a first aspect, the bridge mixer tap comprises a spray, and one pillar permits fluid flow to the spout via the interconnection, while the other pillar is sealed from the spout in the interconnection.

In a second aspect, a handle on one tap pillar is used to control the relative proportion of two fluid supplies (e.g. a hot and a cold fluid supply) while a handle on the other tap pillar is used to control the amount of fluid supplied to the spout, and optionally also to a spray.

Accordingly, in a first aspect the present invention may provide a bridge mixer tap comprising:
a) a first tap pillar and a second tap pillar in a spaced apart relationship, each pillar comprising an inlet conduit, a flow controller for controlling flow from the inlet conduit, and an operator for operating the flow controller, the flow controller having an outlet for the controlled flow;
b) a laterally extending bridge connecting the first and second tap pillars containing a duct which is in fluid communication with an outlet conduit of the second tap pillar and sealed from the first tap pillar;
c) a spout which extends from the bridge and is in fluid communication with the duct;
d) a spray unit having an inlet conduit; and
e) a valve, which is in fluid communication with the outlet of the flow controller of the first tap pillar and the outlet of the flow controller of the second tap pillar, and has a first outlet port in fluid communication with the outlet conduit of the second tap pillar, and a second outlet port in fluid communication with the inlet conduit of the spray unit, wherein the valve is arranged to restrict fluid flow from said first outlet port when there is fluid flow from said second outlet port.

Normally, the valve will be arranged wholly to block fluid flow from the first outlet port when there is fluid flow from the second outlet port. However, there may be circumstances where the valve may be arranged to permit a limited degree of flow from the first outlet port when there is fluid flow from the second outlet port. This latter may also occur due to incomplete sealing of the first outlet port when there is fluid flow from the second outlet port.

Thus the first aspect of the present invention permits a tap arrangement in which there is fluid flow from the second tap pillar to the spout but the portion of the bridge intermediate the first tap pillar and the spout is sealed.

In a second aspect the present invention may provide a bridge mixer tap comprising:
a) a first tap pillar and a second tap pillar in a spaced apart relationship;
b) a laterally extending bridge connecting the first and second tap pillars comprising a duct; and
c) a spout which extends from the bridge and is in fluid communication with the duct,
wherein the first tap pillar comprises a first and a second inlet conduit, a mix controller for adjustably controlling the ratio of flow from the first and second inlet conduits, and an operator for operating the mix controller, the mix controller having an outlet for the mixed flow; and
wherein the second tap pillar comprises an inlet conduit in fluid communication with the outlet of the mix controller, a flow controller for controlling flow from said inlet conduit, and an operator for operating the flow controller, the flow controller having an outlet for the controlled flow, and the second tap pillar further having a flow path extending from the outlet of the flow controller to the duct.

A bridge mixer tap, according to the second aspect of the present invention, may comprise a spray unit having an inlet conduit, and a valve, wherein the valve is in fluid communication with the outlet of the flow controller, and has a first outlet in fluid communication with the duct, and a second outlet in fluid communication with the inlet conduit of the spray unit, and wherein the valve is arranged to restrict fluid flow from said first outlet port when there is fluid flow from said second outlet port.

In both the first and the second aspect of the present invention, each tap pillar may have a mounting means intermediate its upper and lower ends for engagement with a mounting surface provided with holes through which portions of the tap pillars below the mounting means extend.

In both the first and the second aspect of the present invention, the laterally extending bridge preferably connects portions of the tap pillars above the mounting means, i.e. the bridge is preferably located above a mounting surface when the bridge mixer tap is mounted on said surface. As is the case in the first aspect of the present invention, the duct of the laterally extending bridge in the second aspect of the present invention may be sealed from the first tap pillar.

In the first aspect of the present invention, the flow controllers are preferably located in portions of the first and second tap pillars below the mounting means, i.e. the flow controllers are preferably located below a mounting surface when the bridge mixer tap is mounted on said surface.

Alternatively, the flow controller of the first tap pillar may be located in a portion of the first tap pillar above the mounting means.

Similarly, in the second aspect of the present invention, the mix controller and the flow controller are preferably located in portions of the first and second tap pillars below the mounting means, i.e. the flow controllers are preferably located below a mounting surface when the bridge mixer tap is mounted on said surface. The mix controller may be a rotary valve.

In both the first and the second aspect of the present invention, the flow controller for controlling the flow of fluid (e.g. water) through the pillar may be part of a standard gate valve mechanism. This may comprise a spindle which has two ends, one end being connected to an operator and the other bearing a screw thread, which interacts with a screw thread on the gate of the gate valve. Rotation of the operator causes rotation of the spindle, and, by interaction of the screw threads, lifting or lowering of the gate, which has a fixed orientation. This lifts the gate on and off the seat of the valve and hence controls the flow of water through the pillar. Alternatively, one end of the spindle may be connected to the gate of the gate valve, while the other end bears a screw thread, which interacts with a screw thread provided on the inner surface of a hollow operator. In this case, the orientation of the spindle is fixed and hence rotation of the operator causes lifting or lowering of the spindle and gate, by interaction of the screw threads.

In the arrangement described herein, when the gate is on the seat of the valve, the valve blocks flow into the tap pillar from the inlet conduit. When the gate is lifted off the seat of the valve, water is able to flow into the valve from the inlet conduit. Alternatively, rotatable ceramic valves may be used in which the relative rotation of two ceramic discs having apertures therein aligns or misaligns the apertures to permit water to flow from the inlet conduit when alignment occurs.

In both the first and the second aspect of the present invention, the first and second tap pillars will normally be hot and cold tap pillars although this is not essential to the invention.

In the first aspect of the present invention (and also in the second aspect of the present invention, if a valve and spray unit arrangement is present), the valve may be a shuttle valve. The spray unit may comprise a control for controlling fluid flow from the spray unit. If the valve is a shuttle valve, the shuttle valve may operate automatically in response to the control on the spray unit, so that when the control on the spray unit is operated, the shuttle valve operates so as to close the fluid path from the valve to the spout. Thus, the control on the spray unit then simultaneously activates flow from the spray unit and blocks the spout. When the control on the spray unit prevents flow from the spray unit, the shuttle valve adopts a position which permits fluid flow to the spout.

The control may take any of the known forms, but preferably comprises a lever or button which is operable by the thumb of the user, where depression of the lever or button opens the outlet port of the valve to the spray unit and permits water flow from the spray unit.

It would also be possible to provide a valve which also performed the actions of the control on the spray unit, by closing the fluid path to the spray unit when that spray unit was not in use. However, it would then be necessary for the user to be able to control the position of the valve, to switch between flow to the spray unit and flow to the spout, and such control may not be easy to achieve, particularly when the valve is located below the surface on which the mixer tap is mounted.

In both the first and the second aspect of the invention it should be noted that the terms ‘above’ and ‘below’ the mounting means are used to indicate directions relative to the mounting means, and do not imply a particular orientation of the tap relative to the earth. Of course, in normal use they will also refer to directions relative to a surface when the bridge mixer tap is mounted on said surface.

The surface may be a work surface, e.g. a kitchen or bathroom worktop, in which case the laterally extending bridge is displaced vertically above the work surface.

Alternatively, the bridge mixer tap may be wall mounted, e.g. on a kitchen or bathroom wall, in which case the mounting surface will be upright and the bridge mixer tap will be displaced laterally relative to the ground.

### BRIEF DESCRIPTION OF THE DRAWINGS

Embodiments of the invention are described below by way of example, with reference to the accompanying drawings in which:

FIG. 1 shows the front view of a bridge mixer tap according to a first embodiment of the invention.

FIG. 2 shows an enlarged version of section B in FIG. 1.

FIG. 3 shows a sectional view of a bridge mixer tap according to the first embodiment of the invention.

FIG. 4 shows the front view of a bridge mixer tap according to a second embodiment of the invention.

FIG. 5 shows a sectional view of a bridge mixer tap according to the second embodiment of the invention.

FIG. 6 shows, in perspective, a bridge mixer tap according to a third embodiment of the invention.

FIG. 7 shows the front view of a bridge mixer tap according to the third embodiment of the invention.

FIG. 8 shows a cross-sectional view taken along line C-C in FIG. 7.

FIG. 9 shows a sectional view of a bridge mixer tap according to the third embodiment of the invention.

FIG. 10 shows a sectional view of section B in FIG. 9.

### DETAILED DESCRIPTION

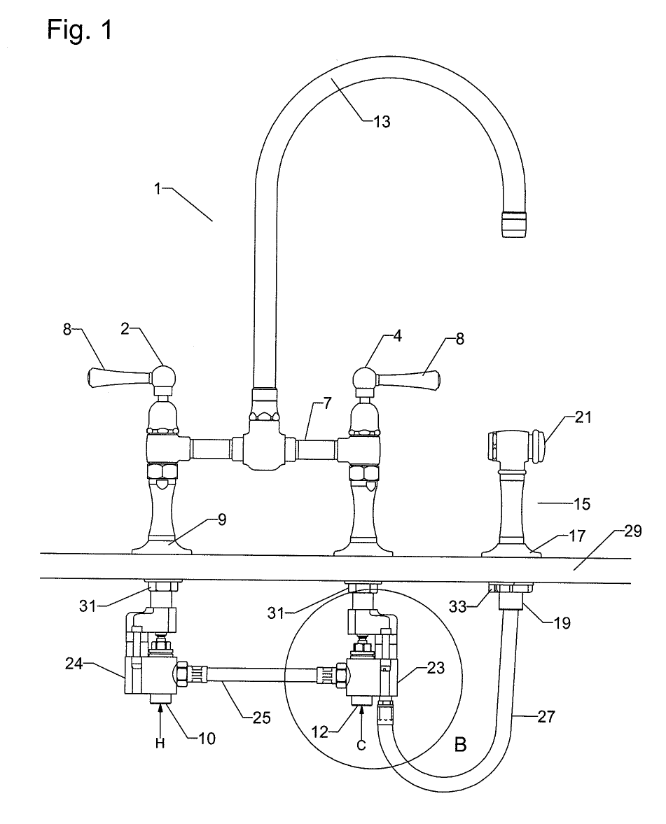

Referring to FIG. 1, a bridge mixer tap 1 according to a first embodiment of the invention has two spaced apart tap pillars 2 and 4, connected by a bridge 7. A spout 13 extends upwards from the middle of the bridge 7. The tap pillars 2 and 4 may each comprise a deck flange 9 for mounting the bridge mixer tap 1 on a work surface 29, as shown in FIG. 1. The purpose of the deck flanges 9 is to prevent the tap pillars 2, 4 from slipping through holes formed in the work surface 29 for receiving the tap pillars 2, 4. When mounted on the work surface 29, the tap pillars 2, 4 may be secured in place via a back nut 31.

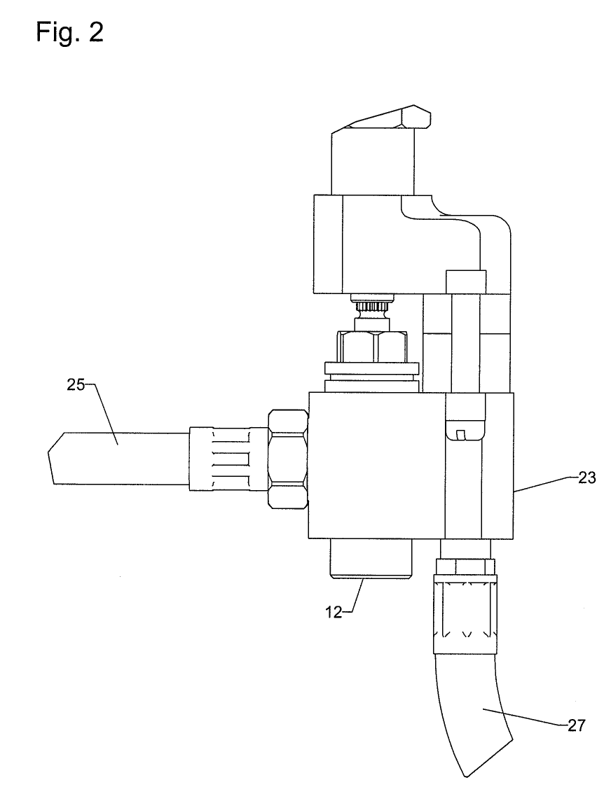

The tap pillars 2, 4 are each topped by a turnable handle 8, and each have an inlet conduit 10 and 12 at their base. The inlet conduits 10, 12 are connectable to a fluid supply, e.g. a hot (H) or cold (C) water supply. For example the inlet conduit 10 may be connected to a hot water supply and the inlet conduit 12 may be connected to a cold water supply, as illustrated in FIG. 1. The tap pillars 2, 4 also each have a valve housing 24 and 23, which are connected via a conduit 25. An enlarged view of the valve housing 23 is shown in FIG. 2.

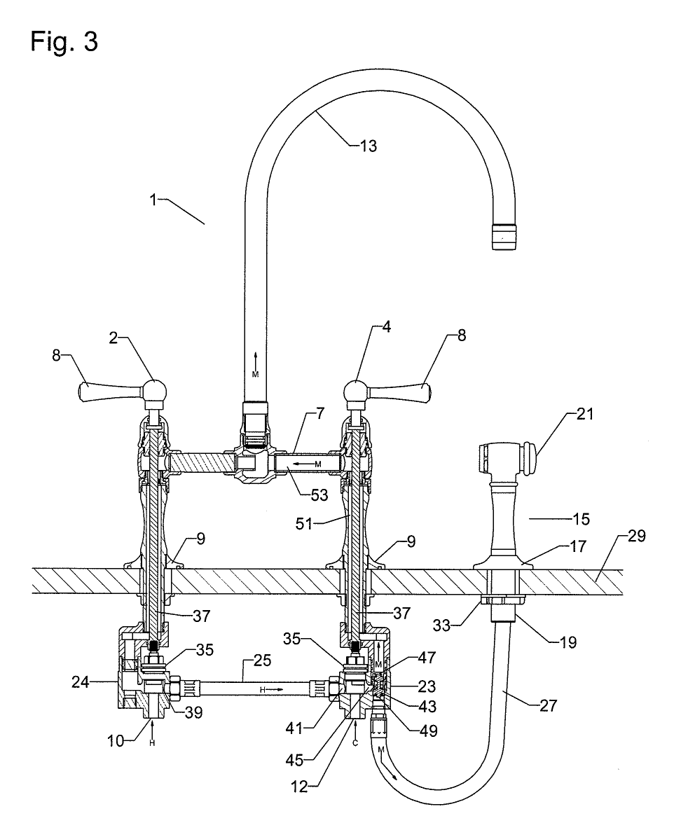

As shown in FIG. 3, the valve housings 23, 24 both contain a valve 35. The valves 35 are connected to turnable handles 8 via shafts 37 of the tap pillars 2, 4. Turning the handle 8, acts to turn the shaft 37, and this raises and lowers the gate of the valve 35 from its seat or rotates the discs of the valve 35 if the valve 35 is a rotatable ceramic valve, thus controlling flow from the inlet conduits 10, 12 into the valves 35.

The valve 35 of the tap pillar 2 has an outlet 39 to the conduit 25. At the other end the conduit 25 is connected to an inlet 41 of the valve housing 23 of the second tap pillar 4, thus allowing controlled fluid flow from the inlet conduit 10 of the first tap pillar 2 to the inlet conduit 41 of the valve housing 23 of the second tap pillar 4.

The bridge mixer tap 1 of the first embodiment of the invention also has a spray unit 15, which may be removably mounted in a deck flange 17 of a housing 19. The spray unit 15 may be connected to the valve housing 23 of the second tap pillar via a flexible conduit 27, and may have a spring-loaded actuator 21 (e.g. a thumb-operated button), for controlling fluid flow through the spray unit 15. Instead of a spring-loaded actuator, the spray unit 15 may have a dial for controlling fluid flow through the spray unit 15.

The housing 19 of the spray unit 15 may be mounted on a work surface 29. When mounted on a work surface 29, the housing 19 extends through a hole formed in the work surface 29, for receiving the housing. The housing 19 may have a deck flange 17 to prevent the housing 19 from slipping through the hole formed in the work surface 29, and the housing 19 may be secured in place by a back nut 33. The flexible conduit 27 is long enough to enable the spray unit 15 to be lifted away from the housing 19. When the spray unit 15 is lifted away from the housing 19, the flexible conduit 27 slides up through the middle of the housing 19 to accommodate this movement.

The bridge mixer tap 1 of the first embodiment of the invention also has a second valve 43 for directing fluid flow to either the spout 13 or to the spray unit 15. For example, the valve 43 may be a shuttle valve. The valve 43 may be contained in the valve housing 23 as shown in FIG. 3. Alternatively, the valve 43 may be arranged between the first and second tap pillars 2, 4. Preferably, the valve 43 is located below the work surface 29, when the bridge mixer tap 1 is mounted on a work surface.

The valve 43 has a first inlet port connected to the inlet port 41 of the valve housing 23 and a second inlet port connected to an outlet port 45 of the valve 35 of the valve housing 23. The inlet ports of the valve 43 can either be connected to the inlet port 41 and outlet port 45 directly or via conduits.

The valve 43 has a first outlet 47 connected to an outlet conduit 51 of the tap pillar 4. The outlet conduit 51 is connected to a duct 53 of the bridge 7, and the duct 53 of the bridge 7 is connected to the spout 13. It is important to note, that in the first embodiment of the invention (as well as in the second and third embodiments of the invention, described in detail below), the duct 53 is not connected to the first tap pillar 2 and mixed fluid can therefore only reach the spout 13 via the second tap pillar 4. The valve 43 has a second outlet 49 connected to the flexible conduit 27 of the spray unit 15.

When the spring loaded actuator 21 of the spray unit 15 is actuated, fluid can flow through the flexible conduit 27, and out of the spray unit 15. This flow causes the valve member of the valve 43 to move so as to close the fluid flow path to the outlet 47, thereby preventing fluid flow through the outlet conduit 51 the duct 53 and hence to the spout 13. Thus, when the spring loaded actuator 21 is actuated, flow from the spout 13 is prevented. When the spring loaded actuator is not actuated, it prevents fluid flow from the spray unit 15, and the valve member of the valve 43 moves so as to permit fluid flow from the outlet 47 via the outlet conduit 51 and the duct 53 to the spout 13. The mixer tap then operates as a normal mixer tap, without a spray unit. Alternatively, it could be envisaged that an actuator for operating the valve 43 could be located on the second tap pillar 4 or in between the first and the second tap pillar 2, 4. Indeed, it would then be possible to modify the valve 43 so that its actuator moves between a position in which fluid passes to the spout 13, but flow to the spray unit 15 is blocked, to a position in which fluid could pass to the spray unit 15, and flow to the spout 13 was blocked. The spring loaded actuator 21 could then be omitted. However, such an arrangement would need the user to be able to control the valve 43 to switch between the two fluid flow routes and this would not be easy in an arrangement in which the valve 43 is located below the work surface 29.

When the bridge mixer tap 1 of the first embodiment of the invention is mounted on a work surface 29, as shown in FIG. 1, the bridge 7, connecting the tap pillars 2, 4 is located above the work surface 29 and the valve housings 24, 23, containing the valves 35, are located under the work surface 29.

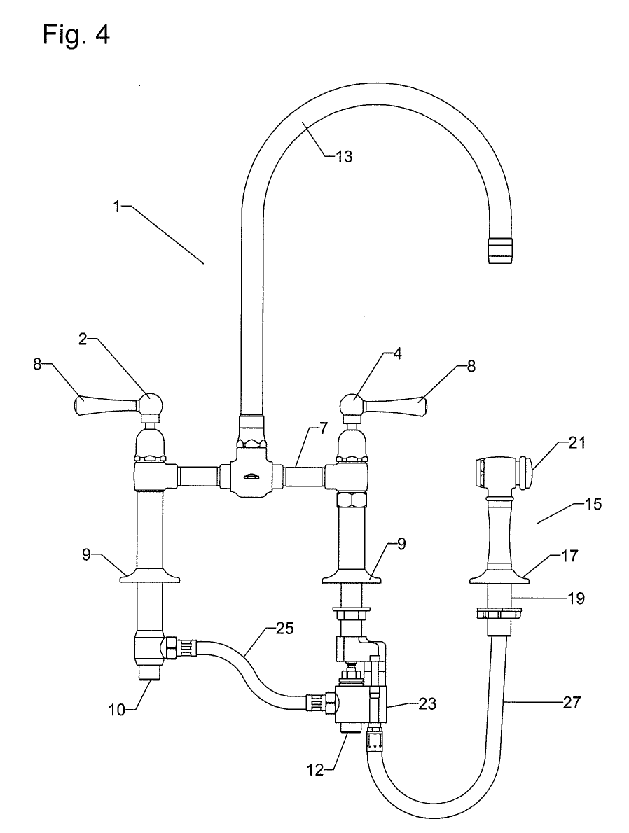

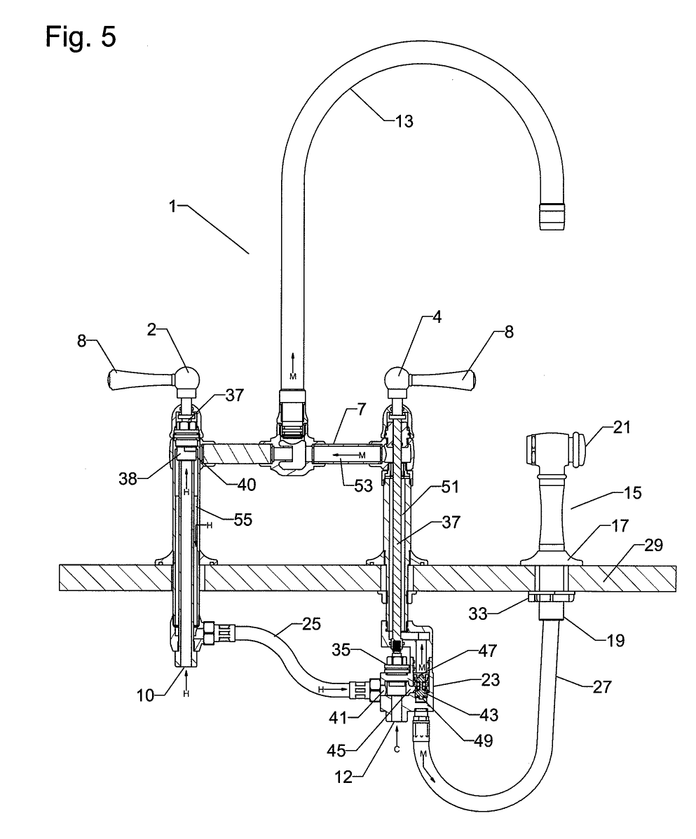

In a second embodiment of the invention, as illustrated in FIGS. 4 and 5, the first tap pillar 2 has a valve 38, which is located above the work surface 29 when the bridge mixer tap 1 is mounted on the work surface 29. This is in contrast to the first embodiment of the invention, where the valve 35 of the first tap pillar 2 is located below the work surface 29, when the bridge mixer tap 1 is mounted on the work surface 29.

However, the second embodiment of the invention also has many features which are similar to features of the first embodiment, and these are indicated by the same reference numbers.

The valve 38 is connected to the turnable handle 8 of the first tap pillar 2 via the shaft 37. Turning the handle 8, acts to turn the shaft 37, and this raises and lowers the gate of the valve 38 from its seat or rotates the discs of the valve 38 if the valve 38 is a rotatable ceramic valve, thus controlling flow from the inlet conduit 10 into the valve 38.

Due to the position of the valve 38, in the second embodiment, an outlet conduit 55 extends down through the tap pillar 2, to connect the outlet 40 of the valve 38 of the first tap pillar 2 with the conduit 25. The outlet conduit 55 may form a sleeve around the inlet conduit 10.

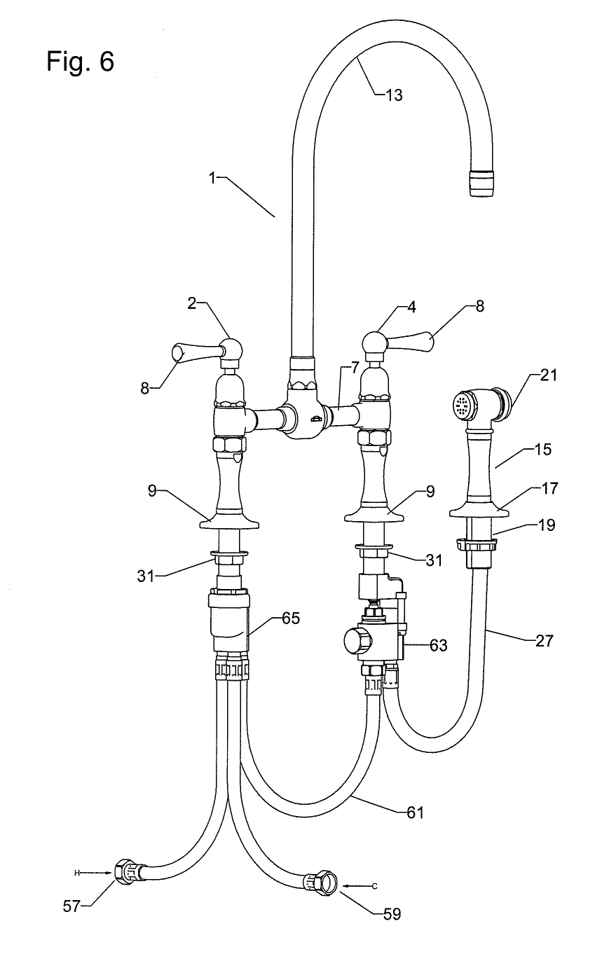

In a third embodiment of the invention, illustrated in FIGS. 6 to 10, the first tap pillar 2 has a valve housing 65 connected to two inlet conduits 57 and 59. This is in contrast with the single inlet conduit 10 connected to the first tap pillar in the first and second embodiments of the invention. However, the third embodiment of the invention also has many features which are similar to features of the first and second embodiments, and these are indicated by the same reference numbers.

In the third embodiment of the invention, the inlet conduits 57, 59 are connectable to a fluid supply, e.g. a hot (H) or cold (C) water supply. For example, the inlet conduit 57 may be connected to a hot water supply and the inlet conduit 59 may be connected to a cold water supply, as illustrated in FIG. 6.

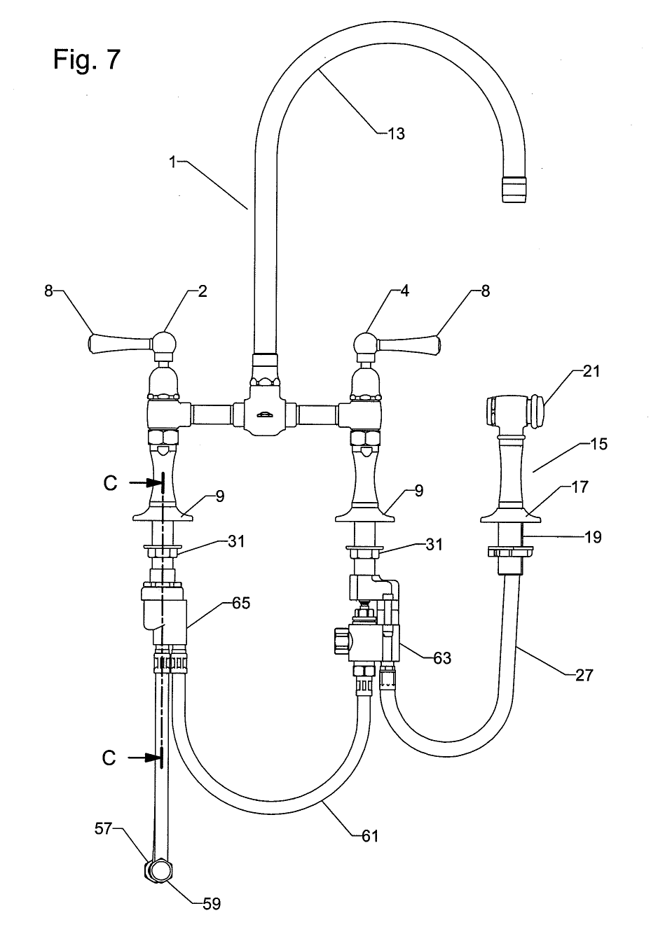

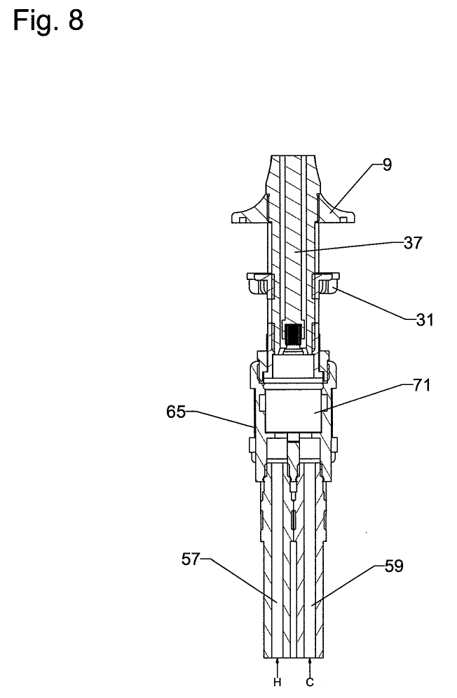

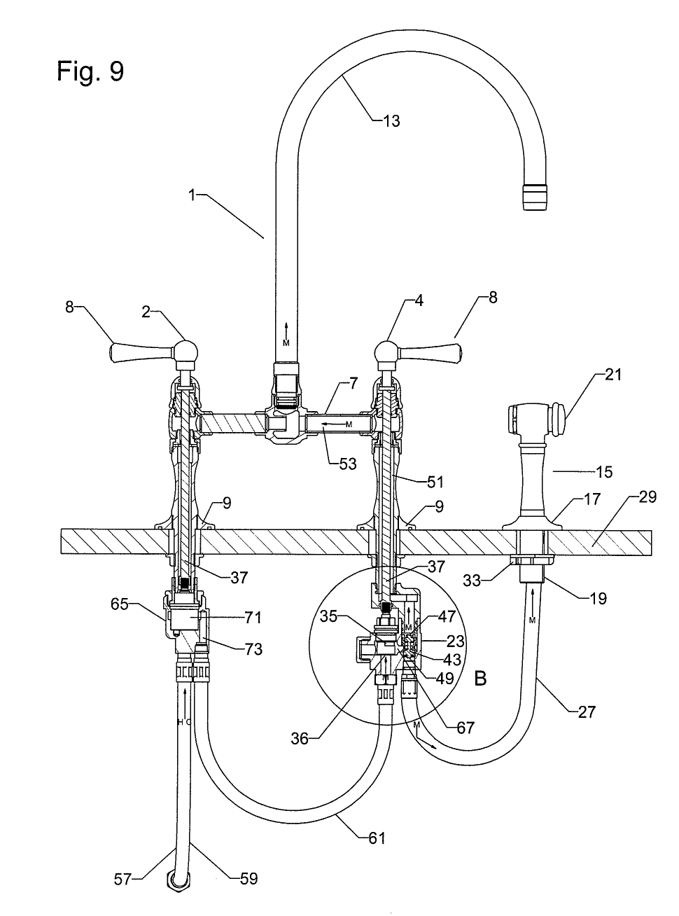

The inner workings of the valve housing 65 are illustrated in FIG. 8, which shows a cross-sectional view taken along line C-C in FIG. 7. The valve housing 65 contains a mixing valve 71, e.g. a rotary valve. The mixing valve 71 may be located below the deck flange 9 and the back nut 31, for mounting the bridge mixer tap 1 on a surface, as shown in FIG. 9. In this case, the mixing valve 71 is positioned below the work surface when the bridge mixer tap 1 mounted on a work surface. Alternatively, the mixing valve 71 may be positioned above the deck flange 9 and the back nut 31 and hence be positioned above the work surface when the bridge mixer tap is mounted on a work surface. In this case the inlet conduits 59, 57 will extend up the tap pillar 2 to the mixing valve 71 and an outlet conduit 73 will extend down the tap pillar 2, for feeding the mixed fluid output of the mixing valve 71 into the outlet conduit 61.

As illustrated in FIG. 8, the mixing valve 71 has an inlet and controls the relative proportion of fluids that enter the valve from the inlet conduits 57, 59 according to the overlap between the inlet of the mixing valve 71 and the inlet conduits 57, 59. The valve 71 is connected to the turnable handle 8 of the first tap pillar 2 via the shaft 37. Turning the handle 8 acts to turn the shaft 37, and this rotates the inlet of the valve 71, thus controlling flow for the inlet conduits 57, 59 into the valve 71.

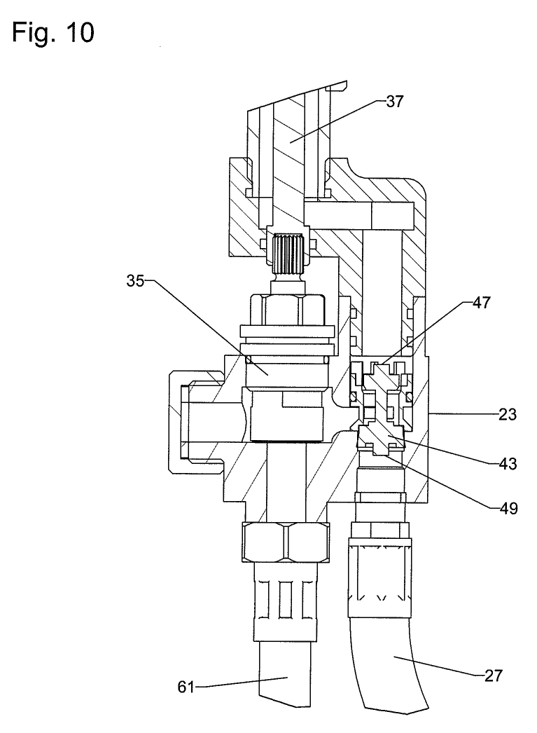

The mixing valve 71 is rotatable from an off position (no overlap) in which no fluid enters the mixing valve 71 from the inlet conduits 57, 59, through a full cold position (full overlap with inlet conduit 59) where all the fluid entering the mixing valve 71 is from the inlet conduit 59, to a full hot position (full overlap with inlet conduit 57) where all the fluid entering the mixing valve 71 is from the hot supply of the inlet conduit 57. Between the full cold and the full hot position, varying relative amounts of the cold and hot supplies of the inlet conduits 59, 57 enter the mixing valve 71. In the full cold position the inlet of the mixing valve 71 overlies the cold supply of the inlet conduit 59, while the hot supply of the inlet conduit 57 is still covered by the valve body. In the full hot position, the inlet of the mixing valve 71 overlies the hot supply of the inlet conduit 57, while the cold supply of the inlet conduit 59 is covered by the valve body. In between these positions the inlet of the mixing valve 71 partially exposes the cold and hot supplies of the inlet conduits 59, 57, to allow different relative proportions of cold and hot water to enter the mixing valve 71. The mixing valve 71 has an outlet 73 connected to a conduit 61. At the other end, the conduit 61 is connected to the inlet 36 of the valve 35 of the second tap pillar 4, as illustrated in more detail in FIG. 10.

As shown in FIG. 9, the valve 35 of the second tap pillar 4 is also connected to the turnable handle 8 via the shaft 37 in the third embodiment of the invention. Turning the handle 8, acts to turn the shaft 37, and this raises and lowers the gate of the valve 35 from its seat or rotates the discs of the valve 35 if the valve 35 is a rotatable ceramic valve. In the third embodiment of the invention the valve 35 controls the amount of mixed flow entering the second tap pillar 4 from the outlet conduit 61.

In the third embodiment of the invention, the presence of the spray unit 15, shown in FIGS. 6, 7 and 9 is optional. If the spray unit 15 is not present, the valve 43, shown in FIGS. 9 and 10 is redundant. Hence, in the absence of the spray unit 15, the outlet 67 of the valve 35 may be directly connected to the outlet conduit 51 of the second tap pillar.

What is claimed is:

1. A bridge mixer tap comprising:
a) a first tap pillar and a second tap pillar in a spaced apart relationship, said first tap pillar and said second tap pillar each comprising an inlet conduit, a flow controller for generating controlled flow from said inlet conduit, and an operator for operating said flow controller, said flow controller having an outlet for said controlled flow, said second tap pillar further having an outlet conduit;
b) a laterally extending bridge connecting said first tap pillar and second tap pillar, said bridge containing a duct which is in fluid communication with said outlet conduit of said second tap pillar and is sealed from said first tap pillar;
c) a spout which extends from said bridge and is in fluid communication with said duct;
d) a spray unit having an inlet conduit; and
e) a valve, which is in fluid communication with said outlet of said flow controller of said first tap pillar and said outlet of said flow controller of said second tap pillar, and has a first outlet port in fluid communication with said outlet conduit of said second tap pillar, and a second outlet port in fluid communication with said inlet conduit of said spray unit, wherein said valve is arranged to restrict fluid flow from said first outlet port when there is fluid flow from said second outlet port.

2. A bridge mixer tap according to claim 1, wherein each of said first tap pillar and said second tap pillar has a first end and a second end, and said first tap pillar and said second tap pillar each further have a flange intermediate said first end and said second end.

3. A bridge mixer tap according to claim 2, wherein said flange provided on each of said first tap pillar and said second tap pillar lies between said flow controller and said laterally extending bridge.

4. A bridge mixer tap according to claim 2, wherein said flow controller of said first tap pillar and said laterally extending bridge are both located on said first end of said first tap pillar.

5. A bridge mixer tap according to claim 1, wherein said valve is a shuttle valve.

6. A bridge mixer tap according to claim 1, wherein said spray unit comprises a control for controlling fluid flow from said spray unit.

7. A bridge mixer tap assembly, comprising a bridge mixer tap and a mounting surface,
said bridge mixer tap comprising:
a) a first tap pillar and a second tap pillar in a spaced apart relationship, said first tap pillar and said second tap pillar each having a first end, a second end, and mounting means intermediate said first end and said second end, said first tap pillar and said second tap pillar each further comprising an inlet conduit, a flow controller for generating controlled flow from said inlet conduit, and an operator for operating said flow controller, said flow controller having an outlet for said controlled flow, said second tap pillar further having an outlet conduit;
b) a laterally extending bridge connecting said first tap pillar and second tap pillar, said bridge containing a duct which is in fluid communication with said outlet conduit of said second tap pillar and is sealed from said first tap pillar;
c) a spout which extends from said bridge and is in fluid communication with said duct;
d) a spray unit having an inlet conduit; and
e) a valve, which is in fluid communication with said outlet of said flow controller of said first tap pillar and said outlet of said flow controller of said second tap pillar, and has a first outlet port in fluid communication with said outlet conduit of said second tap pillar, and a second outlet port in fluid communication with said inlet conduit of said spray unit, wherein said valve is arranged to restrict fluid flow from said first outlet port when there is fluid flow from said second outlet port;
wherein said mounting surface is provided with a first hole and a second hole; and
said bridge mixer tap is mounted on said mounting surface, said second end of said first tap pillar extending through said first hole of said mounting surface and said second end of said second tap pillar extending through said second hole of said mounting surface.

8. A bridge mixer tap comprising:
a) a first tap pillar and a second tap pillar in a spaced apart relationship;
b) a laterally extending bridge connecting said first tap pillar and said second tap pillar, said bridge comprising a duct; and
c) a spout which extends from said bridge and is in fluid communication with said duct,
wherein said first tap pillar comprises a first inlet conduit and a second inlet conduit, a mix controller for generating a mixed flow from said first inlet conduit and said second inlet conduit according to an adjustable ratio, and an operator for operating said mix controller, said mix controller having an outlet for said mixed flow; and
wherein said second tap pillar comprises an inlet conduit in fluid communication with said outlet of the mix controller, a flow controller for generating controlled flow from said inlet conduit, and an operator for operating said flow controller, said flow controller having an outlet for said controlled flow, said second tap pillar further having a flow path extending from said outlet of said flow controller to said duct.

9. A bridge mixer tap according to claim 8, further comprising: a spray unit having an inlet conduit, and a valve, wherein said valve is in fluid communication with said outlet of said flow controller, and has a first outlet in fluid communication with said duct, and a second outlet in fluid communication with said inlet conduit of said spray unit, and wherein said valve is arranged to restrict fluid flow from said first outlet port when there is fluid flow from said second outlet port.

10. A bridge mixer tap according to claim 9, wherein said valve is a shuttle valve.

11. A bridge mixer tap according claim 9, wherein said spray unit comprises a control for controlling fluid flow from said spray unit.

12. A bridge mixer tap according to claim 8, wherein said duct is sealed from said first tap pillar.

13. A bridge mixer tap according to claim 8, wherein each of said first tap pillar and said second tap pillar has a first end and a second end, and said first tap pillar and said second tap pillar each further have a flange intermediate said first end and said second end.

14. A bridge mixer tap according to claim 13, wherein said flange on said first tap pillar lies between said mix controller and said laterally extending bridge and said flange on said second tap pillar lies between said flow controller and said laterally extending bridge.

15. A bridge mixer tap according to claim 8, wherein said mix controller is a rotary valve.

16. A bridge mixer tap assembly, comprising a bridge mixer tap and a mounting surface,
said bridge mixer tap comprising:
a) a first tap pillar and a second tap pillar in a spaced apart relationship, each of said first tap pillar and said second tap pillar having a first end, a second end, and mounting means intermediate said first end and said second end;
b) a laterally extending bridge connecting said first tap pillar and said second tap pillar, said bridge comprising a duct; and
c) a spout which extends from said bridge and is in fluid communication with said duct,
wherein said first tap pillar comprises a first inlet conduit and a second inlet conduit, a mix controller for generating a mixed flow from said first inlet conduit and said second inlet conduit according to an adjustable ratio, and an operator for operating said mix controller, said mix controller having an outlet for said mixed flow; and
wherein said second tap pillar comprises an inlet conduit in fluid communication with said outlet of the mix controller, a flow controller for generating controlled flow from said inlet conduit, and an operator for operating said flow controller, said flow controller having an outlet for said controlled flow, said second tap pillar further having a flow path extending from said outlet of said flow controller to said duct; and
wherein said mounting surface is provided with a first hole and a second hole; and
said bridge mixer tap is mounted on said mounting surface, said second end of said first tap pillar extending through said first hole of said mounting surface and said second end of said second tap pillar extending through said second hole of said mounting surface.
